(19) United States
(12) Patent Application Publication
(10) Pub. No.: US 2010/0055981 A1
(43) Pub. Date: Mar. 4, 2010

(54) WIRELESS LAN ADAPTER

(75) Inventor: HSIN-YUNG YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/430,979

(22) Filed: Apr. 28, 2009

(30) Foreign Application Priority Data
Aug. 27, 2008 (CN) 200810304222.7

(51) Int. Cl. H01R 13/66

(52) U.S. Cl. 439/620.21

(57) ABSTRACT

A wireless LAN adapter comprises a main body defining a receiving slot therein; a connecting portion extending from the main body; an end of the connecting portion detachably received in the receiving slot. The connecting portion connects to the main body, thereby the connecting portion can not be easily lost.

### BACKGROUND

1. Technical Field

The disclosure generally relates to wireless LAN adapters and, particularly, to a wireless LAN adapter used on a computer.

2. Description of Related Art

A Wireless LAN adapter is a wireless terminal device using wireless LAN and configured for connecting to the internet or other networks. Wireless LAN adapters can be divided into several types, according to their different interfaces. Wireless LAN adapters having a USB interface for data exchange are widely used.

Currently, the Wireless LAN adapter used on a computer mainly has two types. A first type of the Wireless LAN adapter includes a main body and a connecting portion connecting to the main body. An end of the connecting portion connects to the computer by an interface to achieve wireless connection function. A second type of the Wireless LAN adapter includes a main body, a cover, and a plug extending from the main body. The cover is detachably assembled on the plug for protecting the plug. When the Wireless LAN adapter is to be used, the cover is detached from the plug, and the plug then connects to the computer to achieve wireless connection function.

However, those two types of the Wireless LAN adapters are inconvenient for carrying. The connecting portion is needed when using the first type of the Wireless LAN adapter, furthermore the plug can be easily damaged. The cover of the second type of the Wireless LAN adapter can be separated from the main body and easily lost.

Therefore, there is room for improvement within the art.

### BRIEF DESCRIPTION OF THE DRAWINGS

Many aspects of the wireless LAN adapters can be better understood with reference to the following drawing. The components in the drawing are not necessarily drawn to scale, the emphasis instead being placed upon clearly illustrating the principles of the wireless LAN adapters. Moreover, in the drawing like reference numerals designate corresponding parts throughout the several views, in which

FIG. 1 is a schematic, perspective view of wireless LAN adapter according to an exemplary embodiment.

FIG. 2 is similar to FIG. 1, but viewed from another aspect.

FIG. 3 is a schematic, perspective view of a plug the wireless LAN adapter placed in a receiving slot.

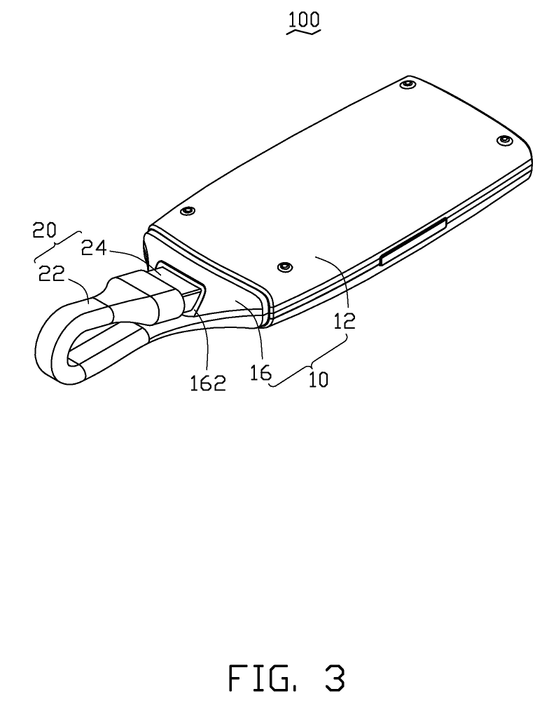

### DETAILED DESCRIPTION OF THE EMBODIMENTS

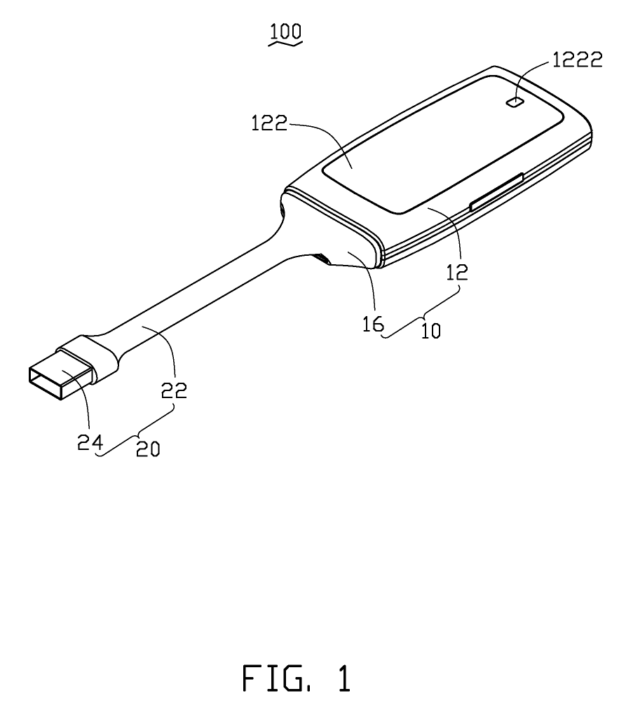

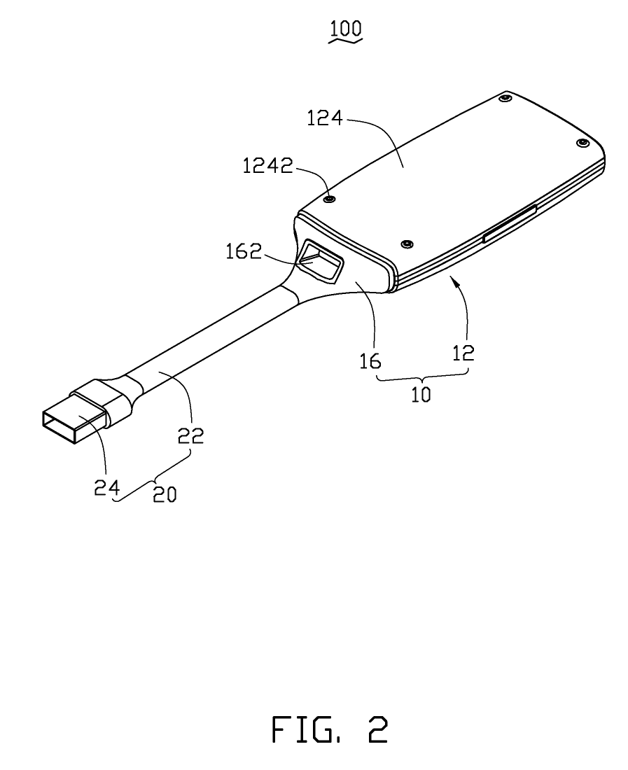

FIGS. 1 and 2 show an exemplary wireless LAN adapter 100 used with a portable electronic device. The wireless LAN adapter 100 includes a main body 10 and a connecting portion 20 extending from the main body 10.

The main body 10 includes a housing portion 12 and an extending portion 16 extending from an end of the housing portion 12. The housing portion 12 includes a first portion 122 and an opposite second portion 124 and holds Wireless LAN circuitry (not shown). The first portion 122 defines an indicator light 1222 thereon configured for indicating whether the wireless LAN adapter 100 is operating normally. The second portion 124 defines four protruding posts 1242 respectively positioned on four corners thereof. The protruding posts 1242 are used as feet to support the main body 10. When the main body 10 is positioned on a worktable (not shown), a distance is formed between the second portion 124 and the supporting body. Thus, the second portion 124 of the housing portion 12 would not be scratched. The extending portion 16 defines a receiving slot 162 therein.

The connecting portion 20 includes a flexible arm 22 and a plug 24. The flexible arm 22 extends from an end of the extending portion 16 adjacent to the receiving slot 162. According to an exemplary embodiment, the flexible arm 22 is a data cable. The plug 24 is positioned on a free end of the flexible arm 22. The flexible arm 22 electrically connects to the computer (not shown) via the plug 24.

When using the wireless LAN adapter 100, the plug 24 is inserted into a USB interface (not shown) for connecting to the internet or other networks. When the wireless LAN adapter 100 not being used, the plug 24 is removed from the USB interface. Then the plug 24 is inserted into the receiving slot 162 when the flexible arm 22 is bent over, thereby the plug 24 can be prevented from being damaged. The flexible arm 22 is bent into a ring-shaped form. Therefore the wireless LAN adapter 100 can be hung up by the flexible arm 22.

It is to be understood that the extending portion 16 can be omitted, the connecting portion 20 can directly extend from an end of the main body 10. The receiving slot 162 can be defined in the housing portion 12 and the plug 24 can be received in the receiving slot 162.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A wireless LAN adapter, comprising:
a main body defining a receiving slot therein;
a connecting portion extending from the main body;
wherein an end of the connecting portion is detachably received in the receiving slot.

2. The wireless LAN adapter as claimed in claim 1, wherein the connecting portion has a plug extending therefrom, the receiving slot is configured for receiving the plug.

3. The wireless LAN adapter as claimed in claim 1, wherein the main body further includes an extending portion extending from an end thereof, the extending portion defines the receiving slot therein.

4. The wireless LAN adapter as claimed in claim 1, wherein the main body further includes a first portion having an indicator light disposed thereon.

5. The wireless LAN adapter as claimed in claim 4, wherein the main body further includes a second portion opposite to the first portion, a plurality of the protruding posts are positioned on the second portion.

6. A wireless LAN adapter, comprising:
a main body having an extending portion extending therefrom and defining a receiving slot therein;
a connecting portion extending from the extending portion and defining a plug on an end thereof, the plug detachably received in the receiving slot.

7. The wireless LAN adapter as claimed in claim 6, wherein the main body further includes a first portion having an indicator light disposed thereon.

8. The wireless LAN adapter as claimed in claim 7, wherein the main body further includes a second portion opposite to the first portion, a plurality of the protruding posts are positioned on the second portion.
